(19) United States
(12) Patent Application Publication
(10) Pub. No.: US 2025/0035811 A1
(43) Pub. Date: Jan. 30, 2025

(54) SCANNING SYSTEMS AND METHODS WITH SHIELD CURTAIN AND INDEPENDENTLY MOVABLE LOW FRICTION LAYER

(71) Applicant: IDSS Holdings, Inc., Armonk, NY (US)

(72) Inventors: James Michael Connelly, Medford, MA (US); Douglas Andrews, Millis, MA (US); Jeffrey J. Hamel, Methuen, MA (US)

(73) Assignee: IDSS Holdings, Inc., Armonk, NY (US)

(21) Appl. No.: 18/360,762

(22) Filed: Jul. 27, 2023

(51) Int. Cl. G01V 5/00

(52) U.S. Cl. CPC G01V 5/226

(57) ABSTRACT

Provided are scanning systems including shield curtain assemblies. A shield curtain assembly may include at least one shield curtain comprising a first material and may further include a low friction material layer. The low friction material layer may comprise a second material having a lower coefficient of friction than the first material. The low friction material layer may be configured to move independently from the at least one shield curtain. When parcels are moved through the scanning systems, the low friction material layer frictionally engages with the parcels and prevents the parcel from frictionally engaging with the shield curtains. The low friction material layer may be independently replaceable from the at least one shield curtain. The independently movable low friction material layer may improve throughput of the scanning systems, improve parcel tracking reliability of the scanning systems, and reduce operating costs of the scanning systems.

### BACKGROUND

Parcel screening is used in various security applications. For example, parcels may be screened by delivery service organizations, at airports or other travel service locations, or otherwise before being allowed into controlled areas. Systems used for parcel screening may include shield curtains for reducing radiation that escapes from the systems.

### BRIEF SUMMARY

According to aspects of the disclosure, there is provided a scanning system comprising a shield curtain assembly comprising at least one shield curtain comprising a first material and a layer comprising a second material having a lower coefficient of friction than the first material, wherein the layer is configured to move independently from the at least one shield curtain.

In some embodiments, the layer is configured to be independently replaceable from the at least one shield curtain. In some embodiments, the scanning system is configured to move a parcel along a parcel motion direction, the layer is disposed a first distance along the parcel motion direction, and at least one shield curtain comprises a first shield curtain disposed a second distance along the parcel motion direction, the second distance greater than the first distance. In some embodiments, the at least one shield curtain is configured to be displaced by a parcel moving through the scanning system and the layer is configured to frictionally engage with the parcel when the at least one shield curtain is displaced by the parcel moving through the scanning system. In some embodiments, the layer is configured to frictionally engage with the at least one shield curtain when the at least one shield curtain is displaced by the parcel moving through the scanning system. In some embodiments, the at least one shield curtain comprises a first shield curtain and a second shield curtain, the first shield curtain and the second shield curtain are configured to be displaced by a parcel moving through the scanning system and the layer is configured to frictionally engage with first shield curtain and the second shield curtain when the first shield curtain and the second shield curtain are displaced by the parcel moving through the scanning system. In some embodiments, the second material comprises polyethylene terephthalate (PET). In some embodiments, the scanning system further comprises a conveyor assembly configured to move a parcel through the scanning system and a scanner configured to emit radiation, wherein the shield curtain assembly is configured to reduce radiation leakage from the scanning system.

According to aspects of the disclosure, there is provided a method of manufacture of a scanning system, comprising arranging, in a shield curtain assembly comprising at least one shield curtain comprising a first material, a layer comprising a second material having a lower coefficient of friction than the first material; and arranging the layer to move independently from the at least one shield curtain.

In some embodiments, the method further comprising replacing the layer without replacing the at least one shield curtain. In some embodiments, the scanning system is configured to move a parcel along a parcel motion direction and at least one shield curtain comprises a first shield curtain, and the method further comprises arranging the layer a first distance along the parcel motion direction and arranging the first shield curtain a second distance along the parcel motion direction, the second distance greater than the first distance. In some embodiments, the method further comprises arranging the at least one shield curtain such that the at least one shield curtain is configured to be displaced by a parcel moving through the scanning system and arranging the layer such that the layer is configured to frictionally engage with the parcel when the at least one shield curtain is displaced by the parcel moving through the scanning system. In some embodiments, the second material comprises polyethylene terephthalate (PET).

According to aspects of the disclosure, there is provided a method of operating a scanning system, comprising moving at least one shield curtain of a shield curtain assembly, the at least one shield curtain comprising a first material and moving, independently from the at least one shield curtain, a layer of the shield curtain assembly, the layer comprising a second material having a lower coefficient of friction than the first material.

In some embodiments, moving the at least one shield curtain comprises moving a parcel through the scanning system thereby displacing the shield curtain and moving, independently from the at least one shield curtain, the layer, comprises moving the parcel through the scanning system thereby displacing the layer. In some embodiments, the layer is configured to be independently replaceable from the at least one shield curtain. In some embodiments, the method further comprises moving a parcel along a parcel motion direction, wherein the layer is disposed a first distance along the parcel motion direction and at least one shield curtain comprises a first shield curtain disposed a second distance along the parcel motion direction, the second distance greater than the first distance. In some embodiments, the method further comprises displacing the at least one shield curtain by moving a parcel through the scanning system and frictionally engaging the layer with the parcel when the at least one shield curtain is displaced by the parcel moving through the scanning system. In some embodiments, the method further comprises frictionally engaging the layer with the at least one shield curtain when the at least one shield curtain is displaced by the parcel moving through the scanning system. In some embodiments, the at least one shield curtain comprises a first shield curtain and a second shield curtain, the first shield curtain and the second shield curtain are configured to be displaced by a parcel moving through the scanning system, and the method further comprises frictionally engaging the layer with first shield curtain and the second shield curtain when the first shield curtain and the second shield curtain are displaced by the parcel moving through the scanning system.

### BRIEF DESCRIPTION OF DRAWINGS

Various aspects and embodiments of the application will be described with reference to the following figures. It should be appreciated that the figures are not necessarily drawn to scale. Items appearing in multiple figures may be indicated by the same reference number in all the figures in which they appear.

FIG. 1 is a side view of a scanning system according to one exemplary embodiment;

FIGS. 2A and 2B are side views of a shield curtain assembly according to one exemplary embodiment;

FIGS. 3A and 3B are side views of a shield curtain assembly according to another exemplary embodiment;

FIG. 4 is a block diagram of a computer system on which various functions can be implemented, according to one exemplary embodiment;

FIG. 5 is a process flow for a method of method of manufacture of a scanning system, according to one exemplary embodiment; and

FIG. 6 is a process flow for a method of operating a scanning system, according to one exemplary embodiment.

### DETAILED DESCRIPTION

Provided are scanning systems including shield curtain assemblies. A shield curtain assembly may include at least one shield curtain comprising a first material and may further include a low friction material layer. The low friction material layer may comprise a second material having a lower coefficient of friction than the first material. The low friction material layer may be configured to move independently from the at least one shield curtain. When parcels are moved through the scanning systems, the low friction material layer frictionally engages with the parcels and prevents the parcel from frictionally engaging with the shield curtains. The low friction material layer may be independently replaceable from the at least one shield curtain. The independently movable low friction material layer may improve throughput of the scanning systems, improve parcel tracking reliability of the scanning systems, and reduce operating costs of the scanning systems.

According to aspects of the disclosure, scanning systems described herein may provide improved ability to pass parcels, including lightweight parcels, through shield curtains of the scanning systems. In some embodiments, shield curtains may physically obstruct parcels passing through a scanning system. For example, the parcels may need move shield curtains from an undeflected position to a deflected position in order to pass through the scanning system. This physical obstruction of parcels by shield curtains may be particularly incident upon lightweight parcels. According to aspects of the disclosure, layers are provided herein that reduce or minimize obstruction of parcels by shield curtains.

Shield curtain assemblies described herein improve efficiency of scanning systems. For example, the shield curtain assemblies may include a low friction layer arranged directly in front of a shield curtain. The low friction layer is configured to engage parcels moving through the system instead of the parcels engaging the shield curtain. The low friction material then pushes up against the shield curtain and pushes them out of the way as the parcel slides along the low friction material. By engaging the low friction layer, instead of the shield curtain, scanning systems described herein reduce drag imparted on parcels passing through the shield curtains. Furthermore, because the low friction material layer is not bound to the shield curtain, both the low friction layer and the shield curtain flex independently, allowing parcels to pass through scanning systems more readily.

Shield curtain assemblies described herein have further advantages. For example, low friction layers described may be independent layers from the shield curtains, as opposed to bonded layers. Scanning systems with independent layers provide the ability to replace either the shield curtain or the low friction material layer without replacing the entire shield curtain assembly. For example, should a low friction material layer degrade, (e.g., through extended wear and tear) the low friction material layer may be replaced while still retaining the shield curtain. That shield curtain may be a more expensive component of a scanning system, and by avoiding replacement of the shield curtain, costs of operating the scanning systems can be reduced.

Items to be scanned by a scanning system may be introduced to the scanning system by persons such as passengers. For example, the items may be placed into trays that are then introduced to the conveyor assembly to pass the trays through the shield curtains to be inspected by the scanner. Based on results of the inspection by the scanner (and in some cases further review by a scanner operator) items may be designated for further processing (such as physically opening the item for a hand search) or may be designated as cleared and routed back to the owner of the item or otherwise sent along (e.g., to be loaded on an aircraft directly in the case of a checked bag). Routing of items to either a cleared lane or a further inspection lane may be carried out by the system automatically, manually, or a combination of both. In some embodiments, even in the case of manual routing, control of items may be based on the scanning system automatically tracking items as they pass through the system, and then directing either a scanner operator or an automated routing system to send the item to its intended lane.

One challenge for a scanning system that automatically tracks items passing through the scanning system is the impact of shield curtains on the motion of items passing through the scanning system. Shield curtains may be included in the scanning system to attenuate radiation escaping from the scanner via entrance and/or exit ports. Shield curtains May include heavy materials such as lead to reduce radiation escape. Shield curtains may also provide a substantial resistance to items that pass through the shield curtains. The resistance may be due to a combination of the weight of shield curtains and the resistance to movement due to a coefficient of friction of surfaces of the shield curtains. In certain applications, such as airport security, larger parcels such as bags may be heavy enough to push through shield curtains. Lightweight or isolated items (e.g., cellphones, wallets, or other lightweight or isolated items) may be placed in trays to help get the item through the curtains. However, without a tray, or even with a tray, lightweight or isolated items may have difficulty passing through shield curtains, and may be either substantially delayed or blocked altogether. The lightweight items may particularly be delayed or blocked by a high coefficient of friction of the shield curtains.

Items being delayed or blocked by shield curtains may reduce the reliability of tracking of items by scanning systems. Automated tracking systems may be based on computer program monitoring, both by conveyor assembly movement, and using imaging or other sensing devices. Such tracking systems may be configured to increase the reliability of tracking items and to fail safely when a tracking error occurs. For example, redundant logic may be employed such that if an item was seen at a first imaging device (e.g., a photo eye), and the conveyor assembly has been moving at a given speed, then the item is predicted to arrive at a second imaging device at a particular time, based on the speed of the conveyor assembly and the distance between the imaging devices. If the item is not detected at the second imaging device within a set margin of error, the scanning system may determine that it cannot trust its inputs and may take measures such as stopping the operation of the scanning system until a scanner operator intervenes to retrieve unprocessed items and reset operation of the scanning system.

Stopping a scanning system due to untrusted inputs may result in significant losses in operational effectiveness of scanning systems. Consequently, items being blocked or delayed as they pass through shield curtains can result in losses of tracking that reduce efficiency of scanning systems that are forced to stop operation while tracking errors are addressed.

Scanning systems may include various shield curtains to block or reduce radiation escaping when scanning baggage or other parcels. In some projection x-ray systems, a radiation level inside the scanner may be relatively low. As such, projection x-ray systems may use only a few layers of shield curtains. Further, when a parcel displaces the shield curtains, the amount of x-ray that leaked out through the parcel is minimal. When computed tomography (CT) technology is used for parcel inspection, radiation containment may be more challenging. CT systems may generate a much higher radiation level within the scanner. To block this increased level of radiation, CT systems may use more shield curtains, and those additional shield curtains may provide additional impedance of parcels moving through the system.

Some conventional systems use heavy automated curtains. The automated curtains may reduce x-ray leakage while they are down, and may be actuated so that they clear the tunnel when lifted. A leading curtain lifts to allow a parcel to be inducted into a shielded portion. A second curtain separating the shielded portion from the scanner remains down, blocking or reducing radiation from escaping. Once a first parcel is inducted into the shielded portion, the first curtain drops, and the second curtain rises. The first parcel proceeds into the scanner while the first curtain reduces the radiation release. Once the first parcel is in the scanner, the second curtain drops, and the first curtain rises allowing the second parcel to enter the shielded portion. Similar operation is carried out at the exit end as the parcel exits the scanner. This conventional approach requires complex coordination between the curtains and parcel motion, and also requires large gaps between parcels. In such a conventional approach, the second parcel may not proceed until the first parcel has left the shielded portion, requiring a minimum of a full parcel length between each pair of consecutive parcels, requiring high amounts of stoppage as parcels are fed into the system. Such a conventional system is incompatible with a desire for a scanning system to maintain small gaps between parcels and move the parcels continuously as they transit the system.

According to some embodiments, to reduce the friction of shield curtains, a different material may be bonded to a face of shield curtains. The different material may have a lower coefficient of friction than the shield curtain. For example, the shielding curtain may comprise a flexible material (e.g., soft plastic matrix) impregnated with a shielding material (e.g., lead or other shielding materials). The flexible material may allow the curtain to flex when engaged with parcels. However, the flexible material may also present a high level of friction to items passing through the curtains. Accordingly, in some embodiments, a lower friction layer (e.g., a layer of harder plastic) may bonded to one or both faces of the soft plastic shielding curtain. The harder plastic may present a lower level of friction than the soft plastic. However, even if the bound layer is itself flexible, the bound combination can result in making the curtain stiffer, resulting in an offsetting impediment to light items passing through the scanner. Furthermore, when the harder plastic degrades, the entire shield curtain must be replaced, including the expensive shielding materials, which increases costs of operating the scanning systems.

Accordingly, aspects of the disclosure provide a reduced friction shield curtain assembly having a shield curtain comprising a first material and a layer comprising a second material having a lower coefficient of friction than the first material, with the layer being configured to move independently from the at least one shield curtain. Such an arrangement provides reduced friction, and therefore improved throughput of the system, enhanced reliability of tracking, and reduced cost of operating the system, compared to conventional systems.

According to aspects of the disclosures, scanning systems may be employed in security environments, for example, contraband detection at an entrance to a controlled area. In various embodiments, scanning systems may include projection x-ray scanners, computed tomography (CT) scanners, or other scanners.

Scanning systems may utilize radiation to interrogate a parcel under inspection to determine whether contents of the parcel are acceptable to pass into the controlled area, or whether the contents may be a cause for concern. Because scanning systems may utilize radiation, such scanning systems may include shielded portions that include shields, such as shield curtains. The scanning systems may use the shields to eliminate or reduce the amount of radiation that may escape from the scanning system and into the environment surrounding the scanning systems.

Parcels entering a scanning system may enter through an entrance port and may exit through an exit port. In some embodiments, an entrance port and exit port may be separate ports. In other embodiments, an entrance port and exit port may be the same port.

In some embodiments, shields of scanning systems may comprise shield curtains. Scanning systems may be configured to reduce, eliminate, or otherwise control emissions from ports using shield curtains. Shield curtains may comprise radiation curtains formed of flexible shielding materials, which form or otherwise deflect to parcels as the parcels are passed through the scanning systems. By forming or deflecting to the parcels, the shield curtains may reduce or minimizing a leakage path that radiation may use to escape from the scanning systems. In some embodiments, the shield curtains may be disposed in a shielded tunnel, which may further reduce or eliminate the leakage paths that radiation may use to escape from the scanning system.

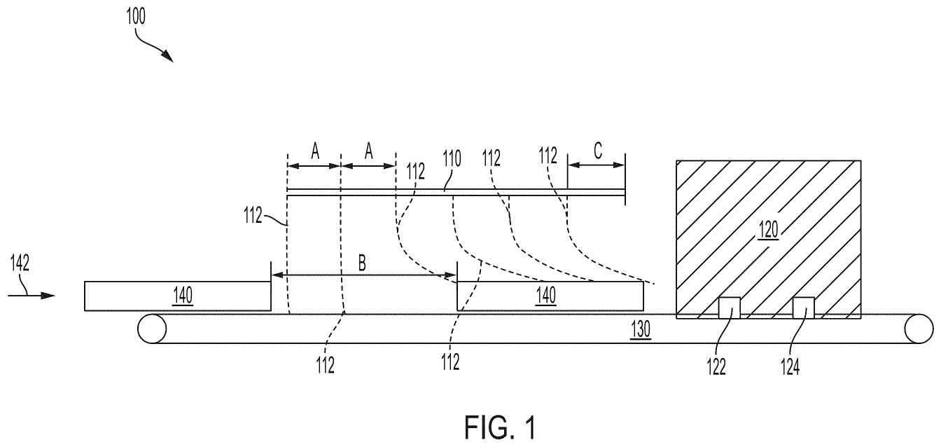

As shown in the exemplary embodiment of FIG. 1, scanning system 100 includes a shielded portion 110, a scanner 120, and a conveyor assembly 130. In various embodiments, a shielded portion, such as shielded portion 110 (which may comprise a shielded tunnel), may include one or more shield curtain assemblies 112. The scanning system is configured to scan parcels 140.

Scanner 120 is configured to scan parcels 140. A parcel such as parcel 140 may comprise an item to be scanned by a scanner. For example, a parcel may include an article that is being transported by a delivery service organization such as the United States Post Office, Federal Express, United Parcel Service, or other delivery service organizations. In various embodiments, a parcel may include any item submitted to a scanning system for inspection, including baggage (e.g., at an airport), personal possessions, manufactured goods, or other items. Scanning systems may be used for inspecting parcels such as baggage and other articles to determine the presence of prohibited items. For example, scanning systems may be used in various environments, such as aviation security, including checked and carry-on baggage, building security, drug interdiction, theft prevention at high value manufacturing, for example, to prevent smuggling out of valuable items such as gemstones or high value integrated circuits, or to establish a secure perimeter or area for VIP protection, and other environments.

In some embodiments, the scanner 120 may comprise at least one emitter, such as emitter 122, which may be an x-ray emitter. In some embodiments, the scanner 120 may comprise at least one detector, such as detector 124, which may be an x-ray detector. In some embodiments, emitter 122 and detector 124 of the scanner 120 may be configured to scan a parcel, for example, by taking an X-ray scan of a parcel 140.

A scanner such as the scanner 120 may have various arrangements of emitters and detectors. While emitter 122 and detector 124 are illustrated in FIG. 1 as being spaced along the parcel motion direction 142 for ease of illustration, the emitter 122 and detector 124 may be disposed in other arrangements for scan parcels 140. As merely one example, the emitter 122 and detector 124 may be spaced along a direction transverse to the parcel motion direction 142 (for example, spaced in the direction into the plane of FIG. 1). In such arrangements, the emitter 122 and detector 124 may be arranged on opposite sides of parcels 140 as the parcels 140 pass through the scanner 120. Still other arrangements of emitters and detectors may be used.

In some embodiments, the parcel is rotated to provide a three-dimensional scan. In other embodiments, the emitter 122 and/or the detector 124 are rotated to provide the three-dimensional scan. In further still embodiments, the parcel and emitter 122 and/or the detector 124 are rotated in conjunction to provide the three-dimensional scan. For example, a scanner such as scanner 120 may provide CT or similar scans.

In some embodiments, a scanner such as scanner 120 may include a computed tomography (CT) scanner. A CT scanner may comprise a device configured to image parcels by using an emitter to emit radiation (e.g., x-rays) on one side of a scanner and use a detector to measure the radiation intensity that passes through a parcel that is being inspected and reaches a far side of the scanner. The CT scanner may vary position of the emitter (e.g., x-ray source) and detector such that they rotate or otherwise move within the scanner. For example, the scanner may physically or electronically move the emitter detector. As the emitter and detector move within the scanner, the scanner may collect projection views of a parcel from a plurality of angles. The scanner may then use data from these plurality of projection angles to produce a three-dimensional image of the parcel. For example, the scanner may combine the projection view through a CT process to produce a three-dimensional mapping of contents of the parcel that is under inspection. The scanner may use the three-dimensional representation of the parcel to prevents scanned objects within the parcel from overlaying with each other, which may remove ambiguity as to the spatial layout of objects within the scanner. In some embodiments, CT scanners collect many views of parcels from many angles, which may require a stronger emission (e.g., x-ray) source in order to capture images.

In some embodiments, a scanner such as scanner 120 may include a projection x-ray scanner. A projection x-ray scanner may comprise a device configured to image parcels by using an emitter to emit radiation (e.g., x-rays) on one side of a scanner and use a detector to measure the radiation intensity that passes through the parcel that is being inspected and reaches a far side of the scanner. In a projection x-ray scanner, the position of the emitter (e.g., x-ray source) and detectors may be fixed. In some embodiments, the projection x-ray scanner may include two or more sets of emitters and detectors. In some embodiments, a projection x-ray scanner may collect a single line of data at a time as the scanning system moves a parcel that is being inspected through the scanner. A projection x-ray scanner may generate an image showing the contents of the parcel projected down on to a display (e.g., a screen) of the scanning system. In some embodiments, the image projected down onto the display may result in objects within the parcel overlaying each other in the image.

A scanning system may have a scan plane. In some embodiments, a scan plan may comprise a portion of the scanning system where a parcel being inspected is illuminated with radiation and information about the parcel is collected. In some scanning systems, there are multiple scan planes, which occur at multiple distinct planes along a conveyor assembly of the scanning system. In some scanning systems, a scan plane may be extended in a parcel motion direction (e.g., a direction along which a conveyor assembly moves a parcel) to form a scan volume. In some embodiments, a scan volume provides a region within the scanning system where parcels articles under inspection are directly illuminated with radiation.

The conveyor assembly 130 is configured to receive parcels. For example, an operator of the scanning system 100 and/or an owner of a parcel 140 may place the parcel 140 onto the conveyor assembly 130. After receiving a parcel 140, the conveyor assembly 130 is configured to move parcels 140 into and out of the scanner 120. The conveyor assembly 130 is configured to move parcels 140 along a parcel motion direction 142. When the conveyor assembly 130 moves parcels 140 along parcel motion direction 142, the parcels 140 pass into scanner 120 through a parcel opening.

The conveyor assembly 130 may be at least partially disposed in the scanner 120. In the scanner 120, the conveyor assembly 130 may be configured to move parcels through the scanner 120. The conveyor assembly 130 may then move parcels 140 so that they pass out of scanner 120 through a parcel opening. The conveyor assembly 130 may further be configured to disseminate parcels. For example, conveyor assembly 130 may be configured to allow an operator of a scanning system and/or an owner of a parcel 140 to retrieve the parcel 140 after the parcel 140 is scanned by scanner 120.

In some embodiments, the parcel motion direction 142 may be different when parcels 140 are moving into and out of the scanner 120. For example, the scanner 120 may have a single parcel opening, and the conveyor assembly may move the parcels 140 along a parcel motion direction 142 into the single opening, and then reverse the parcel motion direction 142 to move the parcels 140 out of the same single opening.

The conveyor assembly 130 may comprise one or more conveyor segments. While in the figures, one conveyor segment may be illustrated, in some embodiments, two or more conveyor segments may perform the functions described herein. In some embodiments, one or more conveyor segments may comprise passive rollers that do not propel parcels. In some embodiments, a conveyor assembly 130 may include a multidirectional conveyor, configured to move parcels in multiple directions.

According to aspects of the disclosure, a scanning system may provide improved methods of reducing friction of shield curtains compared to conventional scanning systems. For example, scanning systems described herein may have an independent layer comprising a low friction material that is arranged in front of the shield curtains. The low fiction layer may be structurally independent from the shield curtain and therefore may be configured to move independently from the shield curtain. Because the low fiction layer may be structurally independent from the shield curtain, the combination of the shield curtain and low friction layer may remain flexible. The improved flexibility allows the shield curtain to still flex around parcels that are being inspected, and the parcels only experience the lower friction of the lower friction layer.

As described, a shield curtain assembly includes one or more shield curtains. A shield curtain may comprise a flexible barrier, including a shielding material, such as lead or another shielding material. A shield curtain may be configured to attenuate radiation (e.g., x-ray) flux while allowing parcels to physically pass through the shield curtain.

In some embodiments, a scanning system may have radiation scatter. Radiation scatter may comprise radiation emissions (e.g., x-rays) that deflect off of a scanning parcel, causing the radiation to change direction. For example, in a scan plane, as a parcel is illuminated with radiation, some portion of the radiation may scatter within the scanner. The scattered radiation may escape the scanning system via a same path the parcels enter and exit the scanning system unless blocked.

According to aspects of the disclosure, various scanning systems may incorporate low friction layers with shield curtains. For example, scanning systems having a variety of arrangements of shield curtains may use the low friction layers. In the exemplary embodiment of FIG. 1, shield curtains are illustrated as being arranged at six locations. Each location may have one or more shield curtains in a shield curtain assembly suspended over the conveyor assembly. At each location, the respective shield curtain assembly may include a layer of low friction disposed leading the shield curtains at that location. The low friction layer may ensure that parcels moving through the scanning system come in contact with the low friction material. In various embodiments, the low friction material may be suspended within the same assembly suspending the shield curtains. When parcels push a low friction material layer, the low friction material layer in turn pushes the shield curtain out of the way as the parcel moves through the scanning system.

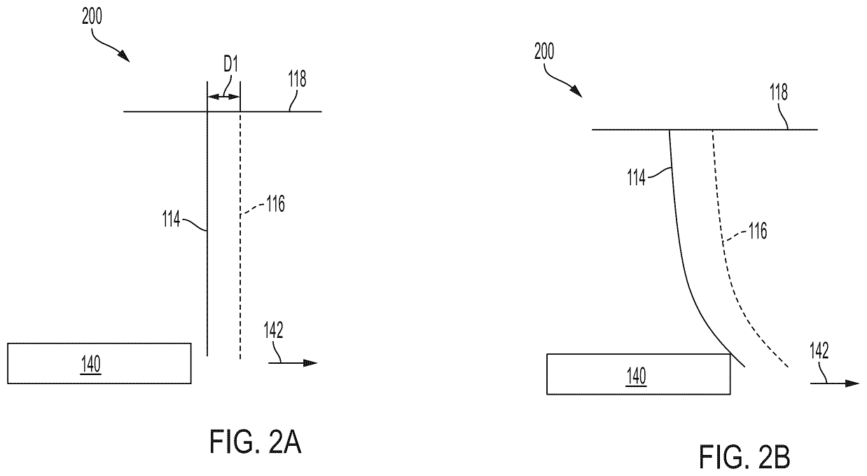

FIGS. 2A and 2B show one embodiment of a shield curtain assembly 200. Shield curtain assembly 200 includes a layer 114, a shield curtain 116, and a superstructure 118. The layer 114 is mounted to the superstructure 118 at first attachment point and the shield curtain 116 is mounted to the superstructure 118 at a second attachment mount.

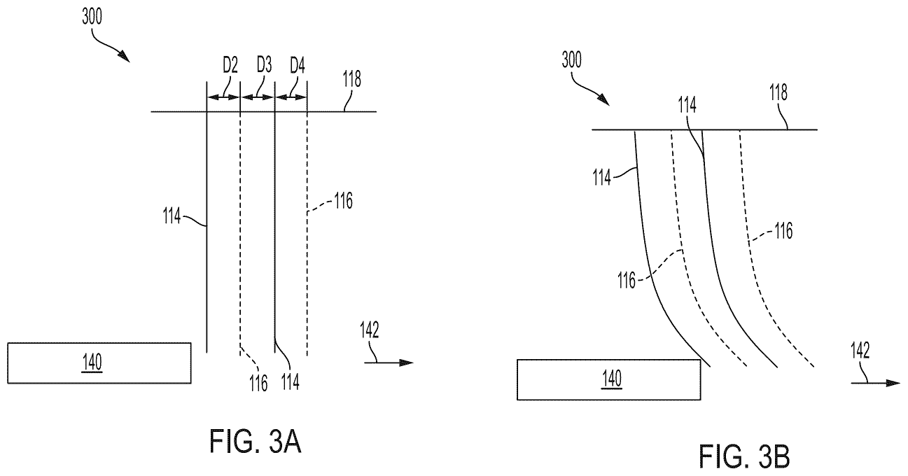

In various embodiments, a shield curtain 116 may comprise different configurations of shield curtains. For example, shield curtain 116 may comprise a single shield curtain or a single layer of shield curtains. While FIGS. 2A and 2B (and also FIGS. 3A and 3B discussed below) illustrate shield curtain 116 as a single layer of shield curtains, other arrangements may be used. As one example, the shield curtain 116 may comprise a shield curtain group. A shield curtain group comprise a one or more shield curtains, such as one or more or multiple layers of shield curtains. In some embodiments where shield curtain 116 comprises a shield curtain group of multiple layers of shield curtains, there may be no layer 114 disposed between the various layers in a particular shield curtain group.

The first attachment point and the second attachment point are spaced at a distance D1. For example, the layer 114 is disposed a first distance along the parcel motion direction 142 and the shield curtain 116 is disposed a second distance along the parcel motion direction 142, with the second distance greater than the first distance. In various embodiments, distance D1 may be greater than about 1 cm, approximately 1 cm, approximately 1 mm, approximately 1 micron, less than 1 micron, or approximately zero. For example, the first attachment point may be approximately concurrent with the second attachment point, with the layer 114 arranged in direct contact with the shield curtain at the attachment points.

The layer 114 and the shield curtain 116 may be independently replaceable. For example, the layer 114 and the shield curtain 116 may comprise distinct components each separately mountable to the superstructure. In some embodiments, the layer 114 and the shield curtain 116 may not be bonded to each other. For example, the layer 114 and the shield curtain may be held together at the attachment point by a clamp gripping the layer 114 and the shield curtain 116, a bolt through the layer 114 and the shield curtain 116, or using another fastener, or another attachment mechanism, which may be a nonpermanent attachment mechanism.

The layer 114 and the shield curtain 116 may comprise different materials having different coefficients of friction. For example, the shield curtain 116 may comprise a first material. The first material may include a material configured to shield radiation. In some embodiments, the first material may comprise a material configured to have a third material embedded within the shield curtain, that third material being configured to shield radiation (such as lead). The first material may have a high coefficient of friction (such as a flexible plastic).

The layer 114 may comprise a second material having a lower coefficient of friction than the first material. For example, the second material may be a low friction material. A low friction material may comprise a wide range of materials. For example, the second material may comprise a material with a low coefficient of friction, a high flexibility, a high durability, and/or a low cost. In various embodiments, the tradeoffs between the preceding material characteristics may be balanced depending on the specific environment of a scanning system. For example, a scanning system that is difficult to repair might prioritize durability over cost, while a scanning system that has some periods of high throughput and some periods of low throughput might prioritize low friction and/or high flexibility over high durability.

In some embodiments, the second material may comprise polyethylene terephthalate (PET). In other embodiments, the second material may comprise other polymers, such as other polyesters, or other thermoplastic resins, and these other materials may have low coefficients of friction.

In FIG. 2A, the shield curtain assembly 200, including layer 114 and shield curtain 116, is arranged in an undeflected position. Parcel 140 is moved (e.g., by a conveyor assembly) towards the shield curtain assembly 200, along a parcel motion direction 142.

In FIG. 2B, the shield curtain assembly 200, including layer 114 and shield curtain 116, is arranged in a deflected position. Parcel 140 continues to be moved (e.g., by a conveyor assembly) through the shield curtain assembly 200, along the parcel motion direction 142. As shown in FIG. 2B, when the parcel 140 is moved through a scanning system, the shield curtain 116 is configured to be displaced by the parcel 140. Furthermore, the layer 114 is configured to frictionally engage with the parcel 140 when the shield curtain 116 is displaced by the parcel 140 moving through the scanning system. In such embodiments, the layer 114 may prevent the shield curtain 116 from frictionally engaging with the parcel 140. Furthermore, the layer 114 may frictionally engage with the shield curtain 116 when the shield curtain 116 is displaced by the parcel 140.

In some embodiments, shield curtains may be arranged in fewer locations, but with more shield curtains at each location. For example, each location may have two, three, or more shield curtains, along with corresponding low friction layers. For example, in one embodiment, a scanning system may have three locations of shield curtains, and four shield curtains in total, such that one of the locations has two shield curtains. Where multiple shield curtains are arranged at one location, when a parcel pushes through the shield curtains, friction between the shield curtains might result in reduced flexibility as the face of a leading shield curtain frictionally engages with and binds to the face of the trailing shield curtain. To avoid this, systems described herein may have low friction layers arranged between the leading and trailing shielding curtains, in addition to a low friction layer arranged in front of the leading shield curtain. A low friction layer disposed between shielding curtains may reduce the friction between two or more shielding curtains, and a prevent loss of flexibility due to one shield curtain binding to another shield curtain.

FIGS. 3A and 3B show another embodiment of a shield curtain assembly 300, with two or more shield curtains arranged in one location. Shield curtain assembly 300 differs from shield curtain assembly 200 in that shield curtain assembly 300 includes two layers 114 and two shield curtains 116, with elements arranged first along the parcel motion direction 142 being referred to as leading, and elements arranged second along the parcel motion direction 142 being referred to as trailing. Furthermore, a leading layer 114 is spaced at a distance D2 from a leading shield curtain 116, the leading shield curtain 116 is spaced at a distance D3 from a trailing layer 114, and the trailing layer 114 is spaced at a distance D4 from a trailing shield curtain 116. Each of distance D2, distance D3, and distance D4 may be similar to distance D1 described above.

In FIG. 3A, the shield curtain assembly 300, including the two layers 114 and two shield curtains 116, is arranged in an undeflected position. Parcel 140 is moved (e.g., by a conveyor assembly) towards the shield curtain assembly 300, along a parcel motion direction 142.

In FIG. 3B, the shield curtain assembly 300, including two layers 114 and two shield curtains 116, is arranged in a deflected position. Similar as described with respect to shield curtain assembly 200, when the parcel 140 is moved through a scanning system, the leading shield curtain 116 is configured to be displaced by the parcel 140, and the leading layer 114 is configured to frictionally engage with the parcel 140 when the leading shield curtain 116 is displaced by the parcel 140 moving through the scanning system. The leading layer 114 may prevent the leading shield curtain 116 from frictionally engaging with the parcel 140. Furthermore, the leading layer 114 may frictionally engage with the leading shield curtain 116 when the leading shield curtain 116 is displaced by the parcel 140. Similar as described with respect to shield curtain assembly 200, when the parcel 140 is moved through a scanning system, the trailing shield curtain 116 is configured to be displaced by the parcel 140, and the trailing layer 114 is configured to frictionally engage with the parcel 140 when the trailing shield curtain 116 is displaced by the parcel 140 moving through the scanning system. The trailing layer 114 may prevent the trailing shield curtain 116 from frictionally engaging with the parcel 140. Furthermore, the trailing layer 114 may frictionally engage with the trailing shield curtain 116 when the trailing shield curtain 116 is displaced by the parcel 140.

Shield curtain assembly 300 differs from shield curtain assembly 200 in that the leading shield curtain 116 interacts with the trailing layer 114. For example, the trailing layer 114 is configured to frictionally engage with both the leading shield curtain 116 and the trailing shield curtain 116 when the leading shield curtain 116 and the trailing shield curtain 116 are displaced by the parcel 140 moving through the scanning system. As such, the trailing layer 114 prevents the leading shield curtain 116 and the trailing shield curtain 116 from frictionally engaging with each other.

The shield curtain assembly 200 or the shield curtain assembly 300 may be included in a shield portion described herein, such as shielded portion 110. For example, shield curtain assembly 112 of FIG. 1 may comprise the shield curtain assembly 200 or the shield curtain assembly 300.

In some embodiments shield curtains may be arranged with particular spacing to reduce or eliminate escape of radiation. For example, a large number of lighter layers of shield curtains may spread out along the length of shielded portion 110. Parcels may be introduced to the scanning system 100, the spacing of the shield curtains may allow, a leading shield curtain to fall before the parcel hits the trailing shield curtain and lift it. For example, a gap between parcels may be large enough to allow two, three, or more shield curtains to completely fall into the down position. For example, referring to FIG. 1, shield curtain assemblies 112 may be spaced from each other with distance A, parcels may have length of distance B, and a spacing from the trailing shield curtain assembly 112 to the scanner 120 may be distance C. Distance A, distance B, and distance C may be arranged such that a third shield curtain assembly falls off a first parcel before a second parcel hits and lifts a first shield curtain assembly. Such an arrangement may allow for continuous movement of the bags through the tunnel, while still controlling radiation leakage. Individual shield curtain assemblies may be lighter in such an arrangement, but parcels passing through this configuration may be in contact with multiple shield curtain assemblies at the same time. Such an arrangement may increase the drag exerted on the parcels by friction, due to the increased area interacting with the parcel. In such an arrangement, a parcel's motion may bel be impeded due to low parcel mass. Accordingly, such an arrangement may be used in combination with the arrangements of low friction material layers described herein.

In some embodiments, scanning systems described herein may be reconfigurable into at least two scanning arrangements. A scanning arrangement may be a distinct physical arrangement of the components of the scanning system in which scans of parcels may be taken. For example, in two different scanning arrangements, the components of the scanning systems described above, such as scanners, conveyor assemblies, conveyor segments, parcel openings, and shields may be disposed in two different physical locations with respect to each other. The components of these scanning systems, as discussed above, such as scanners, conveyor assemblies, conveyor segments, parcel openings, and shields, may be configured to facilitate the rearrangement of a scanning system, for example, by having modular connection points. In some embodiments a reconfigurable scanning system may have different numbers and arrangements of shield curtains and layers in different scanning arrangements.

While various exemplary embodiments are presented herein, it should be appreciated that these embodiments serve merely as nonlimiting examples. One skilled in the art can readily understand that other configurations of shield curtains assemblies with various low friction materials may be used to according to aspects of the disclosure in order to improving the ability of a scanning system to pass parcels, particularly lightweight parcels, through shield curtains.

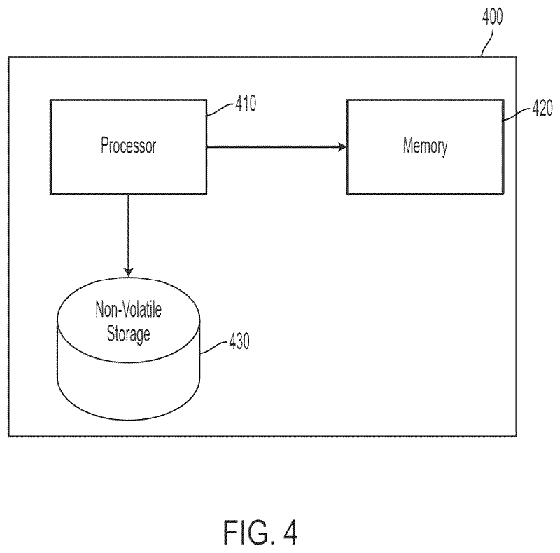

An illustrative implementation of a computer system 400 that may be used in connection with any of the embodiments of the disclosure provided herein is shown in FIG. 4. The computer system 400 may include one or more processors 410 and one or more parcels of manufacture that comprise non-transitory computer-readable storage media, for example, memory 420 and one or more non-volatile storage media 430. The processor 410 may control writing data to and reading data from the memory 420 and the non-volatile storage device 430 in any suitable manner. To perform any of the functionality described herein, for example, scanner control, conveyor segment control, etc., the processor 410 may execute one or more processor-executable instructions stored in one or more non-transitory computer-readable storage media, for example the memory 420, which may serve as non-transitory computer-readable storage media storing processor-executable instructions for execution by the processor 410. For example, scanning systems described herein may include at least one computer system 400 configured to control conveyor assemblies, scanners, and/or other components of the scanning system.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

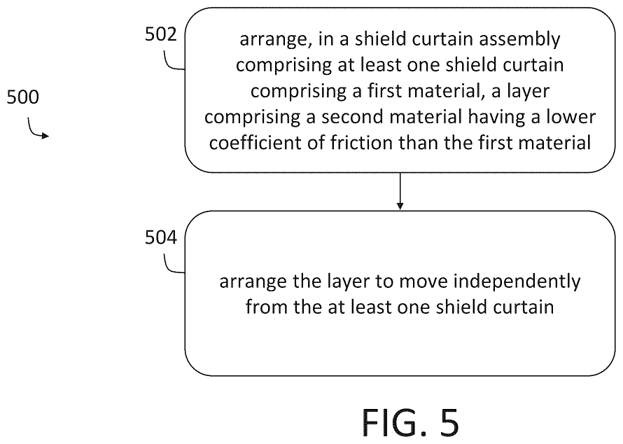

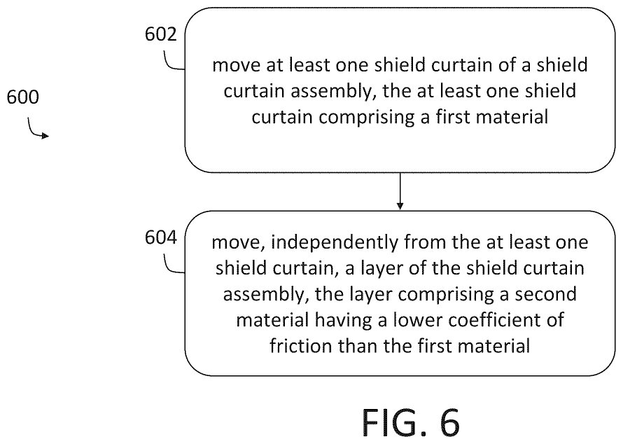

Also, various concepts of the disclosure may be embodied as one or more methods, of which examples, for example, the methods described with reference to FIG. 5 and FIG. 6, have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

FIG. 5 shows a process flow 500 for a method of method of manufacture of a scanning system according to an exemplary embodiment. Process flow 500 comprises step 502 and step 504. At step 502, a manufacturer arranges, in a shield curtain assembly comprising at least one shield curtain comprising a first material, a layer comprising a second material having a lower coefficient of friction than the first material. At step 504, a manufacturer arranges the layer to move independently from the at least one shield curtain. By arranging the layer to move independently from the at least one shield curtain, the shield curtain assembly may engage with parcels with reduced friction, allowing parcels (which may be smaller or lighter parcels) to move through the scanning system, more easily. The process flow 500 may further comprise additional steps such as replacing the layer without replacing the at least one shield curtain.

FIG. 6 shows a process flow 600 for a method of operating a scanning system according to an exemplary embodiment. Process flow 600 comprises step 602 and step 604. At step 602, a scanning system or an operator thereof moves at least one shield curtain of a shield curtain assembly, the at least one shield curtain comprising a first material. At step 604, a scanning system or an operator thereof moves independently from the at least one shield curtain, a layer of the shield curtain assembly, the layer comprising a second material having a lower coefficient of friction than the first material. By moving, independently from the at least one shield curtain, a layer of the shield curtain assembly, the layer comprising a second material having a lower coefficient of friction than the first material, the shield curtain assembly may engage with parcels with reduced friction, allowing parcels (which may be smaller or lighter parcels) to move through the scanning system, more easily. The process flow 600 may further comprise additional steps such as replacing the layer without replacing the at least one shield curtain. In some embodiments, the layer is configured to be independently replaceable from the at least one shield curtain.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B.” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

The terms “approximately,” “substantially,” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A scanning system comprising:
a shield curtain assembly comprising:
at least one shield curtain comprising a first material; and
a layer comprising a second material having a lower coefficient of friction than the first material,
wherein the layer is configured to move independently from the at least one shield curtain.

2. The scanning system of claim 1, wherein:
the layer is configured to be independently replaceable from the at least one shield curtain.

3. The scanning system of claim 1, wherein:
the scanning system is configured to move a parcel along a parcel motion direction;
the layer is disposed a first distance along the parcel motion direction; and
at least one shield curtain comprises a first shield curtain disposed a second distance along the parcel motion direction, the second distance greater than the first distance.

4. The scanning system of claim 1, wherein:
the at least one shield curtain is configured to be displaced by a parcel moving through the scanning system; and
the layer is configured to frictionally engage with the parcel when the at least one shield curtain is displaced by the parcel moving through the scanning system.

5. The scanning system of claim 4, wherein:
the layer is configured to frictionally engage with the at least one shield curtain when the at least one shield curtain is displaced by the parcel moving through the scanning system.

6. The scanning system of claim 1, wherein:
the at least one shield curtain comprises a first shield curtain and a second shield curtain;
the first shield curtain and the second shield curtain are configured to be displaced by a parcel moving through the scanning system; and
the layer is configured to frictionally engage with first shield curtain and the second shield curtain when the first shield curtain and the second shield curtain are displaced by the parcel moving through the scanning system.

7. The scanning system of claim 1, wherein the second material comprises polyethylene terephthalate (PET).

8. The scanning system of claim 1, further comprising:
a conveyor assembly configured to move a parcel through the scanning system; and
a scanner configured to emit radiation,
wherein the shield curtain assembly is configured to reduce radiation leakage from the scanning system.

9. A method of method of manufacture of a scanning system, comprising:
arranging, in a shield curtain assembly comprising at least one shield curtain comprising a first material, a layer comprising a second material having a lower coefficient of friction than the first material; and
arranging the layer to move independently from the at least one shield curtain.

10. The method of claim 9, further comprising replacing the layer without replacing the at least one shield curtain.

11. The method of claim 9, wherein:
the scanning system is configured to move a parcel along a parcel motion direction; and
at least one shield curtain comprises a first shield curtain, and the method further comprises:
arranging the layer a first distance along the parcel motion direction; and
arranging the first shield curtain a second distance along the parcel motion direction, the second distance greater than the first distance.

12. The method of claim 9, further comprising:
arranging the at least one shield curtain such that the at least one shield curtain is configured to be displaced by a parcel moving through the scanning system; and
arranging the layer such that the layer is configured to frictionally engage with the parcel when the at least one shield curtain is displaced by the parcel moving through the scanning system.

13. The method of claim 9, wherein the second material comprises polyethylene terephthalate (PET).

14. A method of operating a scanning system, comprising:
moving at least one shield curtain of a shield curtain assembly, the at least one shield curtain comprising a first material; and
moving, independently from the at least one shield curtain, a layer of the shield curtain assembly, the layer comprising a second material having a lower coefficient of friction than the first material.

15. The method of claim 14, wherein:
moving the at least one shield curtain comprises moving a parcel through the scanning system thereby displacing the shield curtain; and
moving, independently from the at least one shield curtain, the layer, comprises moving the parcel through the scanning system thereby displacing the layer.

16. The method of claim 14, wherein:
the layer is configured to be independently replaceable from the at least one shield curtain.

17. The method of claim 14, further comprising:
moving a parcel along a parcel motion direction, wherein:
the layer is disposed a first distance along the parcel motion direction; and
at least one shield curtain comprises a first shield curtain disposed a second distance along the parcel motion direction, the second distance greater than the first distance.

18. The method of claim 14, further comprising:
displacing the at least one shield curtain by moving a parcel through the scanning system; and
frictionally engaging the layer with the parcel when the at least one shield curtain is displaced by the parcel moving through the scanning system.

19. The method of claim 18, further comprising:
frictionally engaging the layer with the at least one shield curtain when the at least one shield curtain is displaced by the parcel moving through the scanning system.

20. The method of claim 14, wherein:
the at least one shield curtain comprises a first shield curtain and a second shield curtain;
the first shield curtain and the second shield curtain are configured to be displaced by a parcel moving through the scanning system; and
the method further comprises frictionally engaging the layer with first shield curtain and the second shield curtain when the first shield curtain and the second shield curtain are displaced by the parcel moving through the scanning system.
